(19) United States
(12) Patent Application Publication
(10) Pub. No.: US 2021/0094207 A1
(43) Pub. Date: Apr. 1, 2021

(54) INTERIOR TRIM PANEL FOR A VEHICLE AND METHOD OF FORMING AN INTERIOR TRIM PANEL FOR A VEHICLE

(71) Applicant: GM GLOBAL TECHNOLOGY OPERATIONS LLC, Detroit, MI (US)

(72) Inventors: William R. Rodgers, Bloomfield Township, MI (US); Robert Joseph Reuter, Bloomfield Hills, MI (US); Xiaosong Huang, Novi, MI (US); Timothy M. Boundy, Rochester, MI (US); Robert J. Schlenke, Fenton, MI (US); Brian McPeck, Macomb, MI (US)

(21) Appl. No.: 16/589,453

(22) Filed: Oct. 1, 2019

(51) Int. Cl. B29C 43/00; B29B 7/90; B32B 27/20; B60R 13/02

(52) U.S. Cl. CPC B29C 43/003; B29B 7/90; B29K 2511/08; B60R 13/02; B32B 27/20

(57) ABSTRACT

An interior trim panel for a vehicle includes a polymer/leather layer having leather particles each having a diameter of less than 5000 micrometers dispersed within a polymer, and a backing layer adhered to the leather layer and providing a support structure for the polymer/leather layer.

### FIELD

The present disclosure relates to an interior trim panel for a vehicle and method for forming the interior trim panel.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicle interior trim panels may form a part of a vehicle interior such as, for example, an instrument panel, a door panel, a glove box door, an armrest, a headrest, a knee bolster and the like. These vehicle interior trim panels may have a leather surface layer which may be aesthetically pleasing to vehicle occupants. Conventionally, vehicle interior trim panels having a leather surface layer are formed by applying a leather layer to an underlying supporting substrate. The supporting substrate may incorporate a decorative surface that, when covered by a leather surface layer, provides a desirable aesthetic appearance. The leather surface layer is hand laid over the supporting substrate and then pushed, pulled, tucked and pinched into the decorative contour of the underlying supporting substrate. The leather surface layer may then be secured to the underlying supporting substrate using adhesives and/or mechanical fastening systems. The cost of producing these vehicle interior trim panels having a leather surface layer is expensive and time consuming. Further, there are significant limitations on the ability of these conventional processes to provide a vehicle interior trim panel with a leather surface layer that defines a feature having a radius of less than 5 millimeters. It is desirable to provide a vehicle interior trim panel having a leather surface layer with a decorative surface that includes a feature with a radius of less than 5 millimeters. Preferably, it is desirable to provide a vehicle interior trim panel having a leather surface layer with a decorative surface that includes a feature with a radius of less than 3 millimeters and it is even more desirable to provide a vehicle interior trim panel having a leather surface layer with a decorative surface that includes a feature with a radius of less than 1 millimeters.

### SUMMARY

In an exemplary aspect, an interior trim panel for a vehicle includes a polymer/leather layer having leather particles each having a diameter of less than 5000 micrometers dispersed within a polymer, and a backing layer adhered to the leather layer and providing a support structure for the polymer/leather layer.

In another exemplary aspect, the polymer/leather layer defines a feature having a radius of less than 5 millimeters.

In another exemplary aspect, the leather particles each have a diameter of between about 20 to 3000 micrometers.

In another exemplary aspect, the leather particles each have a diameter of between about 40 to 2000 micrometers.

In another exemplary aspect, the leather particles each have a diameter of between about 70 to 1000 micrometers.

In another exemplary aspect, a method of forming an interior trim panel for a vehicle includes dispersing leather particles each having a diameter of less than 5000 micrometers within a polymer, positioning the polymer with dispersed leather particles within a mold that defines a feature having a radius of less than 5 millimeters, molding the polymer with dispersed leather particles within the mold, and removing the polymer with dispersed leather particles from the mold.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of an exemplary method of forming a vehicle interior trim panel in accordance with the present disclosure;

FIG. 2 is a close-up view of a feature of an exemplary vehicle interior trim panel in accordance with the present disclosure;

FIG. 3 is a flowchart of an exemplary method of forming a vehicle interior trim panel in accordance with the present disclosure; and

FIG. 4 is a close-up cross-sectional view of another feature of an exemplary vehicle interior trim panel in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

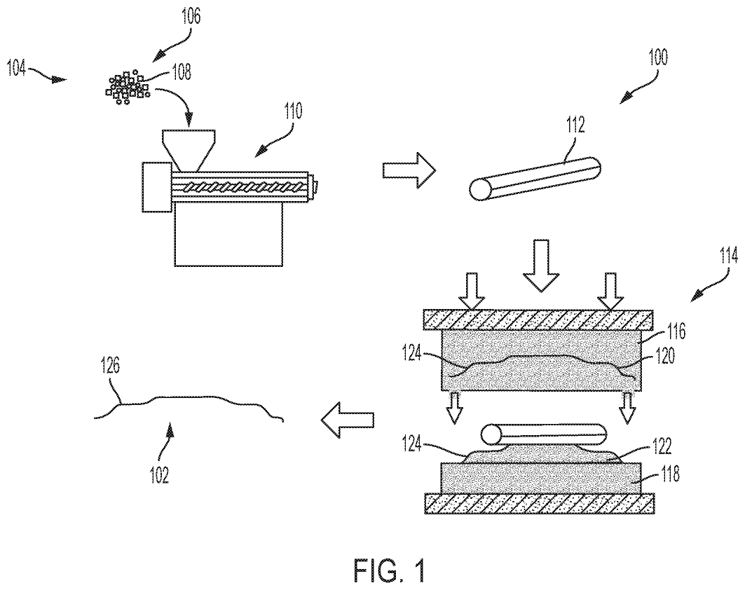

Referring now to the drawings, wherein like reference numbers correspond to like or similar components throughout the several figures, FIG. 1 is a schematic illustration of an exemplary method 100 of forming a vehicle interior trim panel 102 in accordance with the present disclosure. The exemplary method starts by providing leather particles 104 each having a diameter of less than 5000 micrometers dispersed within a polymer 106. In this exemplary method 100, the polymer 106 includes a plurality of polymer particles 108. The mixture of leather particles 104 and polymer particles 108 is then introduced into an extruder 110. The extruder 110 then liquifies the polymer particles 108 by placing the mixture under pressure, further mixes the leather particles 104 with the liquified polymer and extrudes the mixture out of the extruder to produce an extrude charge 112.

Next, the extrude charge 112 is positioned within a compression mold 114 having a first compression molding die 116 and a second compression molding die 118. Each of the first compression molding die 116 and the second compression molding die 118 define complementary surfaces 120 and 122, respectively. Additionally, the complementary surfaces 120 and 122 define a feature 124 having a radius of less than 5 millimeters. Next, the first and second compression molding dies 116 and 118 are brought together placing the extrude charge 112 under compression between them. In response, the extrude charge 112 having leather particles each having a diameter of less than 5000 micrometers dispersed within a polymer may substantially liquefy and flow within the compression mold 114 to, thereby, conform to the complementary surfaces 120 and 122.

Next, the compression mold 114 is opened and the vehicle interior trim panel 102 which is a polymer/leather layer having a feature 126 with a radius of less than 5 millimeters is removed from the compression mold 114. In this manner, the inventive process forms a feature 126 having a radius of less than 5 millimeters which may then be positioned in a vehicle as a vehicle interior trim panel.

Alternatively, rather than molding in a compression mold, it is to be understood that other forms of molding may be used with the present invention without limitation. For example, the leather particles each having a diameter of less than 5000 micrometers dispersed within a polymer may also be molded using roto-mold, slurry mold method and the like. Optionally, the polymer may be in a liquid state for mixing with the leather particles each having a diameter of less than 5000 micrometers prior to molding.

An exemplary material for the polymer 106 may include, for example, thermoplastic polymers chosen from the group of polyvinyl chloride, polyvinylidene chloride, polyvinyl acetate, polyvinyl alcohol, polystyrene, acrylonitrile-styrene polymer, acrylonitrile-butadiene-styrene resin, polyacrylate resin, polymethacrylate, polyethylene, polypropylene, polyamide (PA46, PA6, PA66, PA11, PA12, PA610), fully or partially aromatic polyamide resins, polyacetal resin, polybenzimidazole, polycarbonate, polyethylene terephthalate, polyethylene naphthalate, polyethylene terephthalate, polybutylene terephthalate, polyphenyl ethers, polyphenylene oxides, polyphenylene sulfide, polyethersulfones, polyetherether ketones, polyether ketones, polyetherimides, polylactides, polyoxymethylenes, thermoplastic polyurethanes, or any combination or copolymer of these resins without limitation. One or more of these polymers may be formed into a backing layer and heated above their respective melting point and then co-molded together with the leather article. Alternatively, a thermoset polymer may be provided as the polymer 106 such as, for example: benzoxazine, a bis-maleimide (BMI), a cyanate ester, an epoxy, a phenolic (PF), a polyacrylate (acrylic), a polyimide (PI), an unsaturated polyester, a polyurethane (PUR), a vinyl ester, a siloxane, or any combination or copolymer of these resins without limitation.

Optionally, a backing layer (not shown) may be provided which assists the shaped polymer/leather layer in maintaining the shape that was established during the compression molding operation. A backing layer may be provided to the polymer/leather layer before, during, or after the compression molding operation. If the backing layer is provided during the compression molding operation an exemplary material forming the backing layer may include a polymer such as, for example, thermoplastic polymers chosen from the group of polyvinyl chloride, polyvinylidene chloride, polyvinyl acetate, polyvinyl alcohol, polystyrene, acrylonitrile-styrene polymer, acrylonitrile-butadiene-styrene resin, polyacrylate resin, polymethacrylate, polyethylene, polypropylene, polyamide (PA46, PA6, PA66, PA11, PA12, PA610), fully or partially aromatic polyamide resins, polyacetal resin, polybenzimidazole, polycarbonate, polyethylene terephthalate, polyethylene naphthalate, polyethylene terephthalate, polybutylene terephthalate, polyphenyl ethers, polyphenylene oxides, polyphenylene sulfide, polyethersulfones, polyetherether ketones, polyether ketones, polyetherimides, polylactides, polyoxymethylenes, thermoplastic polyurethanes, or any combination or copolymer of these resins without limitation. One or more of these polymers may be formed into a backing layer and heated above their respective melting point and then co-molded together with the leather article.

Alternatively, a backing material may also be provided as an uncured or b-staged sheet which is clamped into the frame along with the polymer/leather layer. These materials would then be formed and cured during the compression molding operation. Exemplary thermoset material that may be useful as a backing layer includes, for example, may include: benzoxazine, a bis-maleimide (BMI), a cyanate ester, an epoxy, a phenolic (PF), a polyacrylate (acrylic), a polyimide (PI), an unsaturated polyester, a polyurethane (PUR), a vinyl ester, a siloxane, or any combination or copolymer of these resins without limitation.

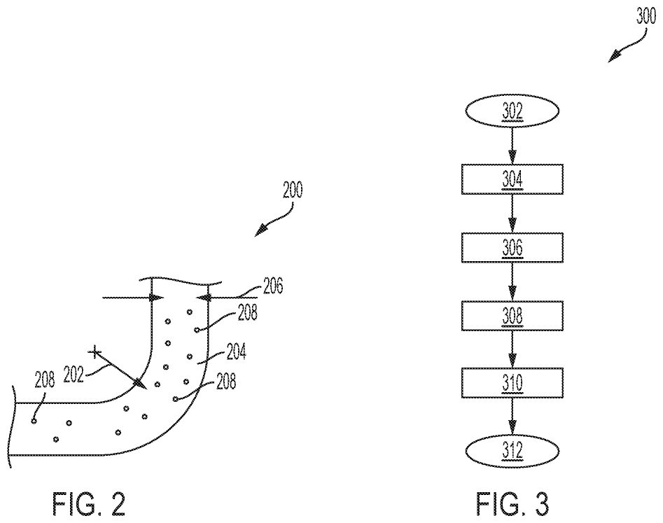

FIG. 2 is a close-up view of a feature of an exemplary vehicle interior trim panel 200 in accordance with the present disclosure. The feature radius 202 of the trim panel 200 is less than 5 millimeters. The vehicle interior trim panel 200 includes a polymer/leather layer 204 having leather particles 208 each having a diameter of less than 5000 micrometers dispersed within a polymer. More preferably, the leather particles 208 each have a diameter of between about 20 to 3000 micrometers. Even more preferably, the leather particles 208 each have a diameter of between about 40 to 2000 micrometers. Yet more preferably, the leather particles 208 each have a diameter of between about 70 to 1000 micrometers. And alternatively, the leather particles 208 each have a diameter between about 100 to 500 micrometers. The leather particles 208 may also each have a thickness between about 20 to 500 micrometers, alternatively between about 40 to 200 micrometers, and yet further alternatively between about 50 to 100 micrometers. The concentration of the leather particles 208 within the polymer/leather mixture may be between 20 to 90 percent by weight, alternatively the concentration of the leather particles 208 within the mixture may be 40 to 80 percent by weight, Yet more preferably the concentration of the leather particles 208 in the polymer/leather mixture may be between 50 to 70 percent by weight. The feature radius 202 of less than 5 millimeters is made possible by forming the vehicle interior trim panel 200 using leather particles each having a diameter of less than 5000 micrometers dispersed within a polymer in accordance with the method described previously with reference to FIG. 1. In this manner, the present invention enables very sharp features in a vehicle interior trim panel having a polymer/leather layer that was previously not possible.

FIG. 3 illustrates a flowchart 300 of an exemplary method of forming a vehicle interior trim panel having a polymer/leather layer including leather particles each having a diameter of less than 5000 micrometers. The method starts at step 302 and continues to step 304 where leather particles each having a diameter of less than 5000 micrometers is dispersed within a polymer and extruded into a molten polymer/leather mixture charge. The method then continues to step 306 where the polymer charge having the dispersed leather particles is positioned within a mold having a first compression molding die and a second compression molding that each define a complementary surface that includes a feature having a radius of less than 5 millimeters. Next the method continues to step 308 where the polymer having dispersed leather particles is molded within the mold. The method then continues to step 310 where the polymer having the dispersed leather particles is removed from the mold. In this manner, the polymer with dispersed leather particles each having a diameter of less than 5000 micrometers dispersed defines a polymer/leather layer with a surface feature having a radius of less than 5 millimeters. The method then continues to step 312 where the method ends.

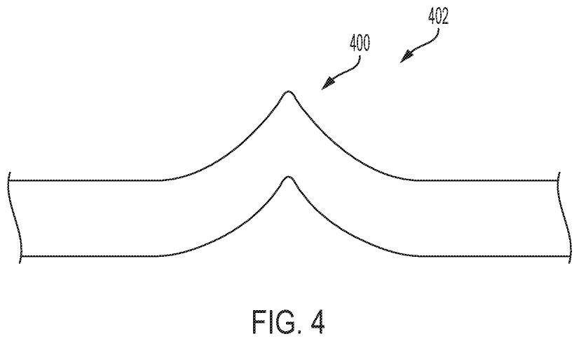

FIG. 4 is a close-up cross-sectional view of another feature 400 of an exemplary vehicle interior trim panel 402 in accordance with the present disclosure. The feature 400 provides a sharp crease line in the vehicle interior trim panel 402. This is in contrast to the features illustrated previously in the present disclosure which generally formed a corner. It is to be appreciated that the term “feature” as used herein is intended to incorporate any shape for the vehicle interior trim panel which may be formed by the inventive aspect a radius of curvature of less than 5 millimeters.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An interior trim panel for a vehicle comprising:
a polymer/leather layer having leather particles each having a diameter of less than 5000 micrometers dispersed within a polymer; and
a backing layer adhered to the leather layer and providing a support structure for the polymer/leather layer.

2. The trim panel of claim 1, wherein the polymer/leather layer defines a feature having a radius of less than 5 millimeters.

3. The trim panel of claim 1, wherein the leather particles each have a diameter of between about 20 to 3000 micrometers.

4. The trim panel of claim 1, wherein the leather particles each have a diameter of between about 40 to 2000 micrometers.

5. The trim panel of claim 1, wherein the leather particles each have a diameter of between about 70 to 1000 micrometers.

6. A method of forming an interior trim panel for a vehicle, the method comprising:
dispersing leather particles each having a diameter of less than 5000 micrometers within a polymer;
positioning the polymer with dispersed leather particles within a mold that defines a feature having a radius of less than 5 millimeters;
molding the polymer with dispersed leather particles within the mold; and
removing the polymer with dispersed leather particles from the mold.

7. The method of claim 6, wherein the polymer with dispersed leather particles defines a polymer/leather layer with a surface feature having a radius of less than 5 millimeters

8. The method of claim 6, wherein the mold comprises a compression mold having a first compression molding die and a second compression molding die, wherein the first compression molding die and the second compression molding dies define complementary surfaces that each define feature having a radius of less than 5 millimeters.

9. The method of claim 6, wherein dispersing the leather particles within a polymer comprises:
providing leather particles;
providing a liquid polymer; and
mixing the leather particles into the liquid polymer.

10. The method of claim 6, wherein dispersing the leather particles within a polymer comprises:
providing leather particles;
providing a granular polymer;
mixing the leather particles with the granular polymer in an extruder; and
extruding the mixture from the extruder.

11. The method of claim 6, wherein the leather particles each have a diameter of between about 20 to 3000 micrometers.

12. The method of claim 6, wherein the leather particles each have a diameter of between about 40 to 2000 micrometers.

13. The method of claim 6, wherein the leather particles each have a diameter of between about 70 to 1000 micrometers.

14. The method of claim 6, further comprising providing a backing layer to the polymer/leather layer after removing the polymer/leather layer from the mold.

15. An interior trim panel for a vehicle formed by the method comprising:
dispersing leather particles each having a diameter of less than 5000 micrometers within a polymer;
positioning the polymer with dispersed leather particles within a mold that defines a feature having a radius of less than 5 millimeters;
molding the polymer with dispersed leather particles within the mold;
removing the polymer with dispersed leather particles from the mold.

16. The interior trim panel of claim 15, wherein the polymer with dispersed leather particles defines a polymer/leather layer with a surface feature having a radius of less than 5 millimeters.

17. The interior trim panel of claim 15, wherein the mold comprises a compression mold having a first compression molding die and a second compression molding die, wherein the first compression molding die and the second compression molding dies define complementary surfaces that each define feature having a radius of less than 5 millimeters.

18. The interior trim panel of claim 15, wherein the leather particles each have a diameter of between about 20 to 3000 micrometers.

19. The interior trim panel of claim 15, wherein the leather particles each have a diameter of between about 40 to 2000 micrometers.

20. The interior trim panel of claim 15, wherein the leather particles each have a diameter of between about 70 to 1000 micrometers.
